(19) United States
(12) Patent Application Publication
(10) Pub. No.: US 2004/0191550 A1
(43) Pub. Date: Sep. 30, 2004

(54) Resin plate

(75) Inventors: Tomohiro Maekawa, Niihama-shi (JP); Kenji Manabe, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/801,570

(22) Filed: Mar. 17, 2004

(30) Foreign Application Priority Data
Mar. 27, 2003 (JP) 2003-087639

(51) Int. Cl. B32B 27/00

(52) U.S. Cl. 428/500

(57) ABSTRACT

A resin plate comprising a base layer and a surface layer placed on at least one side of the base layer is provided. The base layer is made from a methyl methacrylate polymer having about 30% by weight or more of a methyl methacrylate unit as a monomer unit, and the surface layer has a thickness of about 5 μm to about 500 μm and is made from a resin composition containing about 40 parts by weight to about 95 parts by weight of a methyl methacrylate resin and about 5 parts by weight to about 60 parts by weight of a vinylidene fluoride resin with respect to 100 parts by weight in total of the methyl methacrylate resin and the vinylidene fluoride resin. The resin plate has a superior transparency and little deformation due to moisture absorption.

### BACKGROUND OF THE INVENTION

1. Field of the Invention

The present invention relates to a resin plate. In particular, the present invention relates to a resin plate having a superior transparency and little deformation due to moisture absorption.

2. Related Art

A methyl methacrylate polymer containing 30% by weight or more of a methyl methacrylate unit as a monomer unit is useful as a resin having a superior transparency. A resin plate obtained by molding the polymer into a plate shape has been directly used, for example, as a light guide plate which is to be disposed on the backside of a liquid crystal display (see, Japanese Patent Application Laid-Open Nos. 10-265530, 59-68333 and 60-13813).

The resin plate, however, has problems such that the absorption of moisture in the air thereinto easily causes deformation such as warp and wave.

### SUMMARY OF THE INVENTION

The present inventors have studied for developing a resin plate having a superior transparency as well as little deformation due to moisture absorption. As a result, the inventors have found that a resin plate with a sufficient transparency and little deformation such as warp due to moisture absorption can be obtained by placing a surface layer having a thickness of about 5 μm to about 500 μm, which is made from a resin composition containing a methyl methacrylate resin and a vinylidene fluoride resin onto at least one side of a base layer made from a methyl methacrylate polymer containing about 30% by weight or more of a methyl methacrylate unit. The present invention has been accomplished based on such findings.

The present invention provides a resin plate (C) comprising a base layer (A) and a surface layer (B) placed on at least one side of the base layer (A),

wherein the base layer (A) is made from a methyl methacrylate polymer having about 30% by weight or more of a methyl methacrylate unit as a monomer unit, and

the surface layer (B) has a thickness of about 5 μm to about 500 μm and is made from a resin composition containing about 40 parts by weight to about 95 parts by weight of a methyl methacrylate resin and about 5 parts by weight to about 60 parts by weight of a vinylidene fluoride resin with respect to 100 parts by weight in total of the methyl methacrylate resin and the vinylidene fluoride resin.

### BRIEF DESCRIPTION OF THE DRAWINGS

FIGS. 1(a) and 1(b) schematically show cross sectional views of Examples of resin plates in the present invention.

### DETAILED DESCRIPTION OF PREFERRED EMBODIMENTS

A resin plate (C) in the present invention comprises a base layer (A) and a surface layer (B).

The base layer (A) is made from a methyl methacrylate polymer. The methyl methacrylate polymer is a polymer having a methyl methacrylate unit as a monomer unit thereof. The content of the methyl methacrylate unit in the polymer may be about 30% by weight or more, and is preferably about 50% by weight or more. The methyl methacrylate polymer may be a polymer containing 100% by weight of a methyl methacrylate unit, which is a methyl methacrylate homopolymer obtained by polymerizing a methyl methacrylate alone.

Alternatively, the methyl methacrylate polymer may be a copolymer of a methyl methacrylate and a monomer copolymerizable with the methyl methacrylate. Such a copolymerizable monomer may be a styrene-based monomer. Examples of the styrene-based monomer include halogenated styrenes such as chlorostyrene and bromostyrene, substituted styrenes, for example, alkyl styrenes such as vinyltoluene and α-methyl styrene, and the like. When a styrene-based monomer is used, the content of a styrene-based monomer unit in the copolymer may be about 70% by weight or less, preferably about 50% by weight or less; and may be about 10% by weight or more; preferably, about 15% by weight or more.

Examples of the monomer copolymerizable with a methyl methacrylate include methacrylates other than methyl methacrylate, such as ethyl methacrylate, butyl methacrylate, cyclohexyl methacrylate, phenyl methacrylate, benzyl methacrylate, 2-ethylhexyl methacrylate and 2-hydroxyethyl methacrylate; acrylates such as methyl acrylate, ethyl acrylate, butyl acrylate, cyclohexyl acrylate, phenyl acrylate, benzyl acrylate, 2-ethylhexyl acrylate and 2-hydroxyethyl acrylate; unsaturated acids such as methacrylic acid and acrylic acid; acrylonitrile, methacrylonitrile, maleic anhydride, phenylmaleimide, cyclohexylmaleimide, and the like. The monomers can be used each alone, or in combination of two kinds or more of them.

The appropriate thickness and size of the base layer (A) may vary and is suitably selected depending on the usage of the resulting plate (C). For example, in view of an effective inhibition of deformation due to moisture absorption, the thickness is preferably about 0.8 mm to about 5 mm, and the size is preferably 5 cm×5 cm or larger.

A resin laminated plate (C) in the present invention has a surface layer (B) which is placed on or over at least one side of a base layer (A). The surface layer (B) is made from a resin composition containing a methyl methacrylate resin and a vinylidene fluoride resin.

The methyl methacrylate resin is a polymer having a methyl methacrylate unit as a main unit. The methyl methacrylate resin may be a polymer having about 50% by weight or more of a methyl methacrylate unit. The polymer maybe a homopolymer of a methyl methacrylate alone or a copolymer of a methyl methacrylate and a monomer copolymerizable with the methyl methacrylate. Examples of the copolymerizable monomer include the methacrylates as described above (such as methacrylates other than methyl methacrylate), acrylates, unsaturated acids, styrene, α-methyl styrene, acrylonitrile, methacrylonitrile, maleic anhydride, phenylmaleimide, cyclohexylmaleimide, and the like. The monomers can be used each alone or in a combination of two kinds or more of them.

The vinylidene fluoride resin is a polymer having a vinylidene fluoride unit as a main unit. The vinylidene fluoride resin may be a polymer having about 50% by weight or more of a vinylidene fluoride unit. The polymer may be a homopolymer of a vinylidene fluoride alone or a copolymer of a vinylidene fluoride and a monomer copolymerizable with the vinylidene fluoride. Examples of the copolymerizable monomer include trifluoroethylene, tetrafluoroethylene, hexafluoroethylene, hexafluoroisobutene, hexafluoropropylene, perfluoroalkyl vinyl ether, chlorotrifluoroethylene, ethylene, and the like. The monomers can be used each alone or in a combination of two kinds or more of them.

The amount of the methyl methacrylate resin in a resin composition composing a surface layer (B) is about 60 parts by weight to about 95 parts by weight, preferably about 70 parts by weight or more, with respect to 100 parts by weight in total of the methyl methacrylate resin and the vinylidene fluoride resin contained therein. The amount of the vinylidene fluoride resin in the composition is about 5 parts by weight to about 40 parts by weight, preferably about 30 parts by weight or less, with respect to 100 parts by weight in total of the methyl methacrylate resin and the vinylidene fluoride resin contained in the composition.

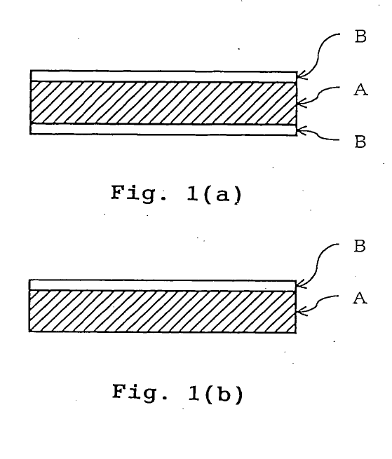

A resin plate (C) in the present invention has a surface layer (B) which is placed onto at least one side of the base layer (A). The surface layer(s) (B) may be laminated on only one side of the base layer (A) as shown in FIG. 1(b), and are preferably laminated on both sides of the base layer (A) as shown in FIG. 1(a).

The thickness of the surface layer (B) is about 5 μm to about 500 μm, and is preferably about 150 μm or more. Also, with regard to the ratio of the thickness (t_{A}) of the base layer (A) to the thickness (t_{B}) of the surface layer (B), the ratio t_{A}/t_{B} may be in a range of from about 1.1/1 to about 99/1 in the case where the surface layer (B) is laminated on only one side of the base layer (A). Meanwhile, in the case where the surface layers (B) are laminated on both sides of the base layer (A), the ratio t_{B}/t_{A}/t_{B} may be in a range of from about 1/2.2/1 to about 1/198/1, and the total thickness of surface layers (B) is preferably about 1/2 or less of the thickness of the base layer (A) in view of cost.

The base layer (A) and the surface layer (B) may contain an additive. Examples of the additive include an ultraviolet absorbing agent. When the ultraviolet absorbing agent is contained, the resulting resin plate (C) has a superior light resistance.

The ultraviolet absorbing agent may be an ultraviolet absorbing agent which can absorb light in a wavelength range of typically from about 250 nm to about 380 nm, preferably having a relative maximum absorption peak at a wavelength in this wavelength range. More preferably, the ultraviolet absorbing agent has a maximum absorption peak at a wavelength (λₘₐₓ) in a wavelength range of from about 250 nm to about 320 nm as the most largest absorption peak in a wavelength range of from about 250 nm to about 800 nm. The molar absorption coefficient (εₘₐₓ) of the ultraviolet absorbing agent in a wavelength range of from about 250 nm to about 320 nm may be about 1000 mol⁻¹cm⁻¹ or more, and is preferably about 5000 mol⁻¹cm⁻¹ or more. Preferably, the molecular weight (Mw) of the agent is about 400 or less, since the amount by weight (based on a mass standard), of the agent to be used can be reduced.

Examples of the ultraviolet absorbing agent include a malonate-based ultraviolet absorbing agent, an acetate-based ultraviolet absorbing agent, an oxalanilide-based ultraviolet absorbing agent, a benzophenone-based ultraviolet absorbing agent, a benzotriazole-based ultraviolet absorbing agent, a cyanoacrylate-based ultraviolet absorbing agent, a salicylate-based ultraviolet absorbing agent, a nickel complex salt-based ultraviolet absorbing agent, a benzoate-based ultraviolet absorbing agent, and the like.

The malonate-based ultraviolet absorbing agent is preferably 2-(1-arylalkylidene) malonates, and more preferably a compound represented by the formula (1).

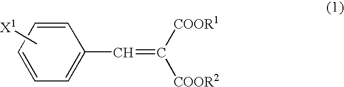

In the formula, X¹ represents a hydrogen atom, an alkyl group or an alkoxyl group, and R¹ and R² each independently represents an alkyl group with a carbon number of 1 to 6.

In the formula (1), as described above, substituent X¹ denotes a hydrogen atom, an alkyl group or an alkoxyl group. The alkyl group may be a linear alkyl group or a branched alkyl group. Example of the alkyl group include an alkyl group with a carbon number of approximately 1 to 6 such as a methyl group, an ethyl group, an n-propyl group, an n-butyl group, an isopropyl group, a sec-butyl group and a tert-butyl group. The alkoxyl group may be a linear alkoxyl group or a branched alkoxyl group. Examples of the alkoxyl group include an alkoxyl group with a carbon number of approximately 1 to 6 such as a methoxy group, an ethoxy group, an n-propoxy group, an n-butoxy group, an isopropoxy group, a sec-butoxy group and a tert-butoxy group. The substituent X¹ is preferably a hydrogen atom and an alkyl group with a carbon number of 1 to 4, and the substituent X is preferably placed in a para-position with respect to the position of vinyl group.

Substituents R¹ and R² each independently denotes an alkyl group. The alkyl group may be a linear alkyl group or a branched alkyl group. Examples of the alkyl group include an alkyl group with a carbon number of approximately 1 to 6 such as a methyl group, an ethyl group, an n-propyl group, an n-butyl group, an isopropyl group, a sec-butyl group and a tert-butyl group.

Examples of the malonate-based ultraviolet absorbing agent represented by the formula (1) include 2-(paramethoxybenzylidene)dimethyl malonate (Mw: 250, λₘₐₓ: 308 nm, εₘₐₓ: 24200 mol⁻¹cm⁻¹).

The acetate-based ultraviolet absorbing agent is preferably a compound represented by formula (2).

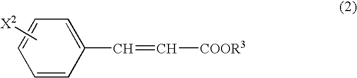

In formula (2), X² represents a hydrogen atom, an alkyl group or an alkoxyl group, and R³ represents an alkyl group.

The alkoxyl group as substituent X² may be a linear alkoxyl group or a branched alkoxyl group. Examples of the alkoxyl group include an alkoxyl group with a carbon number of approximately 1 to 6 such as a methoxy group, an ethoxy group, an n-propoxy group, an isopropoxy group, an n-butoxy group, an isobutoxy group, a sec-butoxy group, a tert-butoxy group and an n-pentoxy group. Preferably the alkoxyl group is an alkoxyl group with a carbon number of approximately 1 to 4. The alkyl group as substituent X² may be a linear alkyl group or a branched alkyl group. Examples of the alkyl group include an alkyl group with a carbon number of approximately 1 to 6, such as a methyl group, an ethyl group, an n-propyl group, an isopropyl group, an n-butyl group, an isobutyl group, a sec-butyl group, a tert-butyl group, an n-pentyl group and an n-hexyl group. The alkyl group is preferably an alkyl group with a carbon number of approximately 1 to 4, and is more preferably a methoxy group. Substituent X² is preferably an alkoxyl group.

The alkyl group as substituent R³ may be an alkyl group with a carbon number of approximately 1 to 10, such as a methyl group, an ethyl group, an n-propyl group, an isopropyl group, an n-butyl group, an isobutyl group, a sec-butyl group, a tert-butyl group, an n-pentyl group, an n-hexyl group, an n-heptyl group, an n-octyl group, an n-nonyl group, an n-decanyl group, a 1-methylpentyl group, a 1-ethylpentyl group, a 1-methylhexyl group and a 2-ethylhexyl group, preferably a methyl group, a 2-ethylhexyl group and the like. Preferably, the alkyl group as substituent R³ is a methyl group and 2-ethylhexyl group.

Examples of the acetate-based ultraviolet absorbing agent represented by the formula (2) include 2-ethylhexyl 2-(paramethoxybenzylidene)acetate (Mw: 290, λₘₐₓ: 304 nm, εₘₐₓ: 23600 mol⁻¹cm⁻¹).

The oxalanilide-based ultraviolet absorbing agent is preferably alkoxyoxalanilides, and more preferably a compound represented by the formula (3).

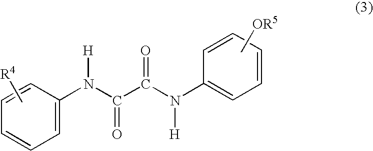

In the formula, R⁴ and R⁵ represent an alkyl group each independently.

In the formula (3), substituents R⁴ and R⁵ each independently denote an alkyl group, and the alkyl group may be a linear alkyl group or a branched alkyl group. Examples of the alkyl group include an alkyl group with a carbon number of approximately 1 to 6 such as a methyl group, an ethyl group, an n-propyl group, an n-butyl group, an isopropyl group, a sec-butyl group and a tert-butyl group. Preferably, the alkyl group is an alkyl group with a carbon number of 1 to 4. The substituent R⁴ is preferably in an ortho-position with respect to the position of the nitrogen atom (N) bonded with the benzene frame. Also, the substituent R⁵O— is preferably in an ortho-position with respect to the position of the other nitrogen atom (N) bonded with the other benzene frame. Examples of the oxalanilide-based ultraviolet absorbing agent represented by the formula (3) include 2-ethoxy-2′-ethyloxalanilide (Mw: 312, λₘₐₓ: 298 nm, εₘₐₓ: 16700 mol⁻¹cm⁻¹).

Examples of the benzophenone-based ultraviolet absorbing agent include 2,4-dihydroxybenzophenone (Mw: 214, λₘₐₓ: 288 nm, εₘₐₓ: 14100 mol⁻¹cm⁻¹), 2-hydroxy-4-methoxybenzophenone (Mw: 228, λₘₐₓ: 289 nm, εₘₐₓ: 14700 mol⁻¹cm⁻¹), 2-hydroxy-4-methoxybenzophenone-5-sulfonic acid (Mw: 308, λₘₐₓ: 292 nm, εₘₐₓ: 12500 mol⁻¹cm⁻¹), 2-hydroxy-4-octyloxybenzophenone (Mw: 326, λₘₐₓ: 291 nm, εₘₐₓ: 15300 mol⁻¹cm⁻¹), 4-dodecyloxy-2-hydroxybenzophenone (Mw: 383, λₘₐₓ: 290 nm, εₘₐₓ: 16200 mol⁻¹cm⁻¹), 4-benzyloxy-2-hydroxybenzophenone (Mw: 304, λₘₐₓ: 289 nm, εₘₐₓ: 15900 mol⁻¹cm⁻¹), 2,2′-dihydroxy-4,4′-dimethoxybenzophenone (Mw: 274, λₘₐₓ: 289 nm, εₘₐₓ: 11800 mol⁻¹cm⁻¹), 1,6-bis(4-benzoyl-3-hydroxyphenoxy)-hexane (Mw: 511, λₘₐₓ: 290 nm, εₘₐₓ: 30100 mol⁻¹cm⁻¹), 1,4-bis(4-benzoyl-3-hydroxyphenoxy)-butane (Mw: 483, λₘₐₓ: 290 nm, εₘₐₓ: 28500 mol⁻¹cm⁻¹), and the like.

Examples of the cyanoacrylate-based ultraviolet absorbing agent include ethyl 2-cyano-3,3-diphenylacrylate (Mw: 277, λₘₐₓ: 305 nm, εₘₐₓ: 15600 mol⁻¹cm⁻¹), 2-ethylhexyl 2-cyano-3,3-diphenylacrylate (Mw: 362, λₘₐₓ: 307 nm, εₘₐₓ: 14400 mol⁻¹cm⁻¹), and the like.

Examples of the salicylate-based ultraviolet absorbing agent include phenyl salicylate (Mw: 214, λₘₐₓ: 312 nm, εₘₐₓ: 5000 mol⁻¹cm⁻¹), 4-t-butylphenyl salicylate (Mw: 270, λₘₐₓ: 312 nm, εₘₐₓ: 5400 mol⁻¹cm⁻¹), and the like.

Examples of the nickel complex salt-based ultraviolet absorbing agent include (2,2′-thiobis(4-t-octylphenolate))-2-ethylhexylamine nickel (II) (Mw: 629, λₘₐₓ: 298 nm, εₘₐₓ: 6600 mol⁻¹cm⁻¹), and the like.

Examples of the benzoate-based ultraviolet absorbing agent include 2′,14′-di-t-butylphenyl 3,5-di-t-butyl-4-hydroxybenzoate (Mw: 436, λₘₐₓ: 267 nm, εₘₐₓ: 20200 mol⁻¹cm⁻¹), and the like.

Examples of the benzotriazole-based ultraviolet absorbing agent include 2-(2-hydroxy-5-methylphenyl)-2H-benzotriazole (Mw: 225, λₘₐₓ: 300 nm, εₘₐₓ: 13800 mol⁻¹cm⁻¹), 5-chloro-2-(3,5-di-t-butyl-2-hydroxyphenyl)-2H-benzotriazole (Mw: 358, λₘₐₓ: 312 nm, εₘₐₓ: 14600 mol⁻¹cm⁻¹), 2-(3-t-butyl-2-hydroxy-5-methylphenyl)-5-chloro-2H-benzotriazole (Mw: 316, λₘₐₓ: 354 nm, εₘₐₓ: 14300 mol⁻¹cm⁻¹), 2-(3,5-di-t-pentyl-2-hydroxyphenyl)-2H-benzotriazole (Mw: 352, λₘₐₓ: 305 nm, εₘₐₓ: 15200 mol⁻¹cm⁻¹), 2-(3,5-di-t-butyl-2-hydroxyphenyl)-2H-benzotriazole (Mw: 323, λₘₐₓ: 303 nm, εₘₐₓ: 15600 mol⁻¹cm⁻¹), 2-(2H-benzotriazole-2-yl)-4-methyl-6-(3,4,5,6-tetrahydrophthalimidylmethyl)phenol (Mw: 388, λₘₐₓ: 304 nm, εₘₐₓ: 14100 mol⁻¹cm⁻¹), 2-(2-hydroxy-5-t-octylphenyl)-2H-benzotriazole (Mw: 323, λₘₐₓ: 301 nm, εₘₐₓ: 14700 mol⁻¹cm⁻¹), and the like.

The above-described ultraviolet absorbing agents may be used each singly or in a combination of two kinds or more of them. Among the ultraviolet absorbing agents, at least one of a malonate-based ultraviolet absorbing agent, an oxalanilide-based ultraviolet absorbing agent, a benzophenone-based ultraviolet absorbing agent, a benzotriazole-based ultraviolet absorbing agent, and the like is preferably used. More preferably, at least one of a malonate-based ultraviolet absorbing agent and an oxalanilide-based ultraviolet absorbing agent is used.

When a resin composition composing a surface layer (B) contains an ultraviolet absorbing agent, the amount of the agent may be about 0.01 part by weight to about 3 parts by weight with respect to 100 parts by weight in total of the methyl methacrylate resin and the vinylidene fluoride resin contained in the composition.

When a resin composition composing a base layer (A) contains an ultraviolet absorbing agent, the amount of the agent contained in the composition for the base layer (A) is less than that of the agent in the composition for surface layer (B). The amount of the agent in the composition for the base layer (A) maybe about 0.005 part by weight to about one (1) part by weight with respect to 100 parts by weight in total of the methyl methacrylate resin and the vinylidene fluoride resin contained in the composition. The amount of the ultraviolet absorbing agent

In the composition for a surface layer (B), the ultraviolet absorbing agent is contained so that the content of the agent in the surface layer (B) is preferably about 0.2 g/m² to about 10 g/m² per unit area. In order to obtain the surface layer (B) containing an ultraviolet absorbing agent in the amount per unit area within this range, it is preferred to determine the quantity of the ultraviolet absorbing agent to be used, the thickness of the surface layer (B) and the like in consideration of, for example, the specific gravity of the resin composition composing the surface layer (B).

When a base layer (A) and/or a surface layer (B) contain(s) an ultraviolet absorbing agent, a hindered amine may be contained therein together with the ultraviolet absorbing agent. The hindered amine allows the resulting resin plate to have a much superior light resistance.

Examples of such a hindered amine include a dimethyl succinate/1-(2-hydroxyethyl)-4-hydroxy-2,2,6,6-tetramethylpiperidine polycondensate, a poly((6-(l,1,3,3-tetramethylbutyl)imino-1,3,5-triazine-2,4-diyl) ((2,2,6,6-tetramethyl-4-piperidyl)imino)hexamethylene((2,2,6,6-tetramethyl-4-piperidyl)imino)), a 2-(2,3-di-t-butyl-4-hydroxybenzyl)-2-n-butylmalonicbis(1,2,2,6,6-pentamethyl-4-piperidyl), a 2-(3,5-di-t-butyl-4-hydroxybenzyl)-2-n-butylmalonicbis(1,2,2,6,6-pentamethyl-4-piperidyl), an N,N′-bis(3-aminopropyl)ethylenediamine/2,4-bis(N-butyl-N-(1,2,2,6,6-pentamethyl-4-piperidyl)amino)-6-chloro-1,3,5-triazine condensate, a bis(2,2,6,6-tetramethyl-4-piperidyl)sebacate, a succinicbis(2,2,6,6-tetramethyl-4-piperidyl), and the like.

The hindered amine may be a compound represented by formula (4).

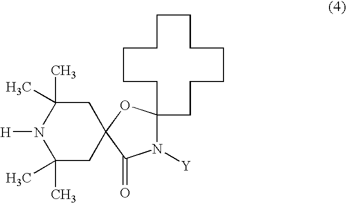

In formula (4), Y represents a hydrogen atom, an alkyl group, a carboxyalkyl group, an alkoxyalkyl group, or an alkoxycarbonylalkyl group.

The alkyl group as substituent Y and the alkyl groups in the carboxyalkyl group, the alkoxyalkyl group and alkoxycarbonylalkyl group as substituent Y in formula (4) may be a linear alkyl group or a branched alkyl group, and may be an alkyl group with a carbon number of 1 to 20. The carboxyalkyl group is preferably a carboxyalkyl group with all carbon numbers of 2 to 20. The alkoxyalkyl group is preferably an alkoxyalkyl group with all carbon numbers of 2 to 25. The alkoxycarbonylalkyl group is preferably an alkoxycarbonylalkyl group with all carbon numbers of 3 to 25. Substituent Y is preferably a hydrogen atom or an alkoxycarbonylalkyl group with all carbon numbers of 5 to 24, is more preferably a hydrogen atom or an alkoxycarbonylethyl group. Examples of the alkoxycarbonylethyl group include a dodecyloxycarbonylethyl group, a tetradecyloxycarbonylethyl group, a hexadecyloxycarbonylethyl group, an octadecyloxycarbonylethyl group, and the like.

The hindered amines may be used each singly or in a combination of two kinds or more of them. The amount of the hindered amine contained in the layer (A) and/or (B) may be about 2 parts by weight or less, and is preferably about 0.01 part by weight to about 1 part by weight, with respect to the ultraviolet absorbing agent contained together.

Examples of the additive also include a surfactant. The surfactant may be contained in either one of a base layer (A) and a surface layer (B) or in both of them. Any of an anionic surfactant, a cationic surfactant, an amphoteric surfactant and a nonionic surfactant can be used in the present invention. Among them, an anionic surfactant such as sulfonic acid, sulfuric monoester and a salt thereof is preferably used. Specifically, the preferable surfactant is sodium lauryl sulfate, sodium cetyl sulfate, sodium stearyl sulfate and the like. The surfactant allows the resulting resin plate in the present invention to further inhibit the occurrence of odd noise due to temperature change. Also, a resin plate containing a surfactant is superior in an antistatic property, desirably.

When a base layer (A) contains a surfactant, the amount of the surfactant in the base layer (A) may be, with respect to 100 parts by weight of the polymer in the layer (A), about one (1) part by weight or less, preferably about 0.7 part by weight or less, and is more preferably about 0.5 part by weight or less; and also is preferably about 0.1 part by weight or more, and more preferably about 0.2 part by weight or more.

When a surface layer (B) contains a surfactant, the amount of the surfactant in the surface layer (B) may be, with respect to 100 parts by weight in total of the methyl methacrylate resin and the vinylidene fluoride resin in the layer (B), about 5 parts by weight or less, is preferably about 3 parts by weight or less, and is more preferably 1 part by weight or less; and also is preferably about 0.1 part by weight or more, more preferably about 0.2 part by weight or more, and is most preferably about 0.3 part by weight or more.

A base layer (A) may also contain a light diffusing agent as an additive. The light diffusing agent allows the resulting resin plate in the present invention to be suitably used as a light diffusing plate.

The light diffusing agent to be used may be a transparent fine particles having a refractive index different from that of the polymer composing a base layer (A), for example, a polymer containing about 30% by weight or more of a methyl methacrylate unit as a monomer unit. The light diffusing agent may be an inorganic light diffusing agent, which is made from an inorganic material, or may be an organic light diffusing agent, which is made from an organic material. The difference in refractive index is preferably about 0.02 or more in view of sufficiently diffusing an incident light, and is preferably about 0.13 or less in view of having a sufficiently large quantity of transmitted light.

Examples of the inorganic light diffusing agent include calcium carbonate, barium sulfate, titanium oxide, aluminum hydroxide, silica (silicon oxide), inorganic glass, talc, mica, white carbon, magnesium oxide, zinc oxide, and the like. The inorganic light diffusing agent may be surface-treated with a surface treating agent such as a fatty acid in order to be dispersed easily and uniformly into a base layer (A), for example, a resin plate of a methyl methacrylate-styrene copolymer.

Examples of the organic light diffusing agent include a styrene-based polymer particle, an acryl-based polymer particle, a siloxane-based polymer particle, and the like.

The styrene-based polymer particle may be a polymer having a styrene-based monofunctional monomer unit as a main unit, such as a polymer containing about 50% by weight or more of a styrene-based monofunctional monomer unit. The polymer may be a homopolymer of a styrene-based monofunctional monomer or may be a copolymer of a styrene-based monofunctional monomer and a monofunctional monomer copolymerizable therewith.

The styrene-based monofunctional monomer may be a compound having a styrene skeleton and one (1) radically polymerizable double bond in its molecule. Examples of the styrene-based monofunctional monomer include styrene and substituted styrene, for example, halogenated styrenes such as chlorostyrene and bromostyrene, and alkyl styrenes such as vinyltoluene and α-methyl styrene, and the like.

The monofunctional monomer copolymerizable with a styrene-based monofunctional monomer may be a compound which has one (1) radically polymerizable double bond in its molecule and is copolymerizable with the styrene-based monofunctional monomer by the double bond. Examples of the monofunctional monomer include methacrylates such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate; acrylates such as methyl acrylate, ethyl acrylate, butyl acrylate, cyclohexyl acrylate, phenyl acrylate, benzyl acrylate, 2-ethylhexyl acrylate and 2-hydroxyethyl acrylate; acrylonitrile; and the like. Among them, methacrylates such as methyl methacrylate are preferably used. The above-described monofunctional monomer may be used each singly or in a combination of two kinds or more of them.

When a styrene-based polymer particle is used as an organic light diffusing agent, the weight-average molecular weight thereof is preferably about 500,000 to about 5,000,000.

The styrene-based polymer particle as an organic light diffusing agent may be a particle made from a copolymer of a styrene-based monofunctional monomer and a polyfunctional monomer copolymerizable with the styrene-based monofunctional monomer, as copolymerization components. The polyfunctional monomer may be a compound which has two (2) or more radically polymerizable double bonds in its molecule and is copolymerizable with a styrene-based monofunctional monomer by the double bond. Examples of the polyfunctional monomer include methacrylates of polyhydric alcohols, for example, 1,4-butanediol dimethacrylate, neopentyl glycol dimethacrylate, ethylene glycol dimethacrylate, diethylene glycol dimethacrylate, tetraethylene glycol dimethacrylate, propylene glycol dimethacrylate, tetrapropylene glycol dimethacrylate, trimethylpropane trimethacrylate and pentaerythritol tetramethacrylate; acrylates of polyhydric alcohols, for example, 1,4-butanediol diacrylate, neopentyl glycol diacrylate, ethylene glycol diacrylate, diethylene glycol diacrylate, tetraethylene glycol diacrylate, propylene glycol diacrylate, tetrapropylene glycol diacrylate, trimethylolpropane triacrylate and pentaerythritol tetraacrylate; an aromatic polyfunctional compound such as divinylbenzene and diallyl phthalate, and the like. The polyfunctional monomers may be used each singly or in a combination of two kinds or more of them.

Such a copolymer of the polyfunctional monomer may be a copolymer made from a polyfunctional monomer and a monofunctional monomer described above as a monofunctional monomer which is copolymerizable with a styrene-based monofunctional monomer.

The copolymer of a styrene-based monofunctional monomer and a polyfunctional monomer copolymerizable therewith is preferably a copolymer having a so-called crosslinked structure and having a gel fraction of about 10% by weight or more.

The styrene-based polymer particle may have a refractive index of from about 1.53 to about 1.61. The styrene-based polymer particle having a larger amount of a benzene frame and/or a halogen atom tends to have a larger refractive index.

The styrene-based polymer particle can be produced by a commonly known method such as a suspension polymerization method, a microsuspension polymerization method, an emulsion polymerization method and a dispersion polymerization method.

An acryl-based polymer particle as an organic light diffusing agent may be a polymer having an acryl-based monofunctional monomer unit as a main unit, such as a polymer containing about 50% by weight or more of an acryl-based monofunctional monomer unit. The polymer may be a homopolymer of an acryl-based monofunctional monomer or may be a copolymer of an acryl-based monofunctional monomer and a monofunctional monomer copolymerizable therewith.

Examples of the acryl-based monofunctional monomer include acrylic acid, methacrylic acid and esters thereof; for example, methacrylates such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate; acrylates such as methyl acrylate, ethyl acrylate, butyl acrylate, cyclohexyl acrylate, phenyl acrylate, benzyl acrylate, 2-ethylhexyl acrylate and 2-hydroxyethyl acrylate; methacrylic acid; acrylic acid; and the like. The acryl-based monofunctional monomers may be used each singly or in a combination of two kinds or more of them.

The monofunctional monomer copolymerizable with an acryl-based monofunctional monomer may be a compound which has one (1) radically polymerizable double bond in its molecule and is copolymerizable with the acryl-based monofunctional monomer by the double bond. Examples of the monofunctional monomer include styrene and substituted styrene, for example, halogenated styrenes such as chlorostyrene and bromostyrene; alkyl styrenes such as vinyltoluene and α-methyl styrene; and acrylonitrile. Such a monofunctional monomers may be used each singly or in a combination of two kinds or more of them.

When an acryl-based polymer particle is used as an organic light diffusing agent, the weight-average molecular weight thereof is preferably about 500,000 to about 5,000,000.

The acryl-based polymer particle as an organic light diffusing agent may be a particle made from a copolymer of an acryl-based monofunctional monomer and a polyfunctional monomer copolymerizable with the acryl-based monomer, as copolymerization components. The polyfunctional monomer may be a compound which has two (2) or more radically polymerizable double bonds in its molecule and is copolymerizable with an acryl-based monofunctional monomer by the double bond. Examples of the polyfunctional monomer include the same polyfunctional monomer as is described above in a styrene-based polymer particle, such as methacrylates of polyhydric alcohols, acrylates of polyhydric alcohols and an aromatic polyfunctional compound. The polyfunctional monomers may be used each singly or in a combination of two kinds or more of them.

Such a copolymer of the polyfunctional monomer may be a copolymer made from a polyfunctional monomer and a monofunctional monomer described above as a monofunctional monomer which is copolymerizable with an acryl-based monofunctional monomer.

The copolymer of an acryl-based monofunctional monomer and a polyfunctional monomer copolymerizable therewith is preferably a copolymer having a crosslinked structure and having a gel fraction of about 10% by weight or more.

The acryl-based polymer particle may have a refractive index of from about 1.46 to about 1.55. The acryl-based polymer particle having a larger amount of a benzene frame or a halogen atom tends to have a larger refractive index. An acryl-based polymer particle can be produced by a commonly known polymerization method such as a suspension polymerization method, a microsuspension polymerization method, an emulsion polymerization method and a dispersion polymerization method.

A siloxane-based polymer particle as an organic light diffusing agent may be a particle made from a siloxane-based polymer. The siloxane-based polymer can be produced by a method of hydrolyzing and condensing chlorosilanes such as dimethyldichlorosilane, diphenyldichlorosilane, phenylmethyldichlorosilane, methyltrichlorosilane and phenyltrichlorosilane. The siloxane-based polymer may be a crosslinked polymer. The crosslinked polymer can be produced by treating a non-crosslinked polymer with a peroxide such as benzoyl peroxide, 2,4-dichlorbenzoyl peroxide, para-chlorbenzoyl peroxide, dicumyl peroxide, di-tert-butyl peroxide, 2,5-dimethyl-2,5-di(tert-butylperoxy)hexane. A polymer having a silanol group at an end, can be produced by condensing and crosslinking chlorosilanes with alkoxysilanes. The crosslinked polymer preferably has a structure having two or three organic residues per one silicon atom. Also, the siloxane-based polymer is preferably a polymer called silicone rubber or silicone resin, and is preferably a polymer in a solid state at normal temperature.

The siloxane-based polymer particle may be obtained by grinding the above-described siloxane-based polymer. Alternatively, the particle may be obtained as a granular particle by curing a curable polymer having linear organosiloxane block and a composition thereof in a spray state (see, Japanese Patent Publication Laid-Open No. 59-68333). Also, the particle may be obtained as a granular particle by hydrolyzing and condensing alkyltrialkoxysilane or a partial hydrolysis condensate thereof in an aqueous solution of ammonia or amines (see, Japanese Patent Application Laid-Open No. 60-13813).

The siloxane-based polymer preferably has a weight-average molecular weight of from about 500,000 to about 5,000,000. When the siloxane-based polymer has a crosslinked structure, the polymer preferably has a gel fraction of about 10% by weight or more. The siloxane-based polymer may have a refractive index of from about 1.40 to about 1.47.

Furthermore, examples of the additive include a impact-resisting agent, a polymer-based antistatic agent, an antioxidant, a flame retardant, a lubricant, a coloring agent such as dyestuff and pigment, and the like. These additives may be contained in either of a base layer (A) and a surface layer (B) or in both of them. Examples of the impact-resisting agent include an acryl-based multilayered rubber particle, a graft rubber-like polymer particle and the like. Examples of the polymer-based antistatic agent include a polyether ester amide and the like. Examples of the antioxidant include hindered phenol and the like. Examples of the lubricant include palmitic acid, stearyl alcohol and the like.

A resin plate in the present invention can be manufactured by a method such as a coextrusion molding method, a laminating method, a thermal adhesion method, a solvent adhesion method, a polymerization adhesion method, a cast polymerization method and a surface application method.

For example, a resin plate in the present invention is produced by a coextrusion molding method in a way such that a methyl methacrylate polymer and a resin composition containing a methyl methacrylate resin and a vinylidene fluoride resin are coextruded. In the coextruding, the polymer and the resin composition may be extruded from a die for coextrusion molding to be integrally laminated while being heated and melt-kneaded by respective discrete extruders. Examples of the extruder to be used include a single or twin screw extruder and the like. Examples of the die to be used include a feed block die, a multi-manifold die and the like. The polymer coextruded from a die may be made into a base layer (A), while the resin composition coextruded may be made into a surface layer (B). The polymer and the resin composition are coextruded may then be interposed in a chill roll by using a roll unit so as to be cooled, whereby being made into an intended resin plate.

When a base layer (A) contains an additive, the base layer (A) can be formed in a way such that the additive is mixed into a methyl methacrylate polymer to be coextruded. The additive can be mixed by a commonly known method. For example, the additive can be added to a methyl methacrylate polymer by an extruder so as to be melt-kneaded. When a surface layer (B) contains an additive, the surface layer (B) can be formed in a way such that the additive is mixed into a resin composition to be coextruded. The additive can be mixed by a commonly known method. For example, the additive can be added to a methyl methacrylate resin and a vinylidene fluoride by an extruder so as to be melt-kneaded.

When a resin plate in the present invention is produced by a laminating method, the resin plate can be produced in a way such that a methyl methacrylate polymer is molded into a plate shape and then a resin composition containing a methyl methacrylate resin and a vinylidene fluoride resin is laminated thereto in heating and melting state. After cooling the laminated resin composition to be solidified, the resin composition is made into an ultraviolet absorbing layer, whereby obtaining an intended resin plate.

When a resin plate in the present invention is produced by a thermal adhesion method, the resin plate can be produced in a way such that a methyl methacrylate polymer is molded into a plate shape and then a film (which may be obtained by a method such that a resin composition containing a vinylidene fluoride resin and an ultraviolet absorbing agent is molded into a film shape) is pressed thereon to be integrated while being heated. In the production method, the methyl methacrylate polymer and the resin composition may be pressed while being heated up to a temperature of softening point thereof or higher, whereby the plate-shaped methyl methacrylate polymer and the film are integrally laminated by being heat-fused to obtain an intended resin plate.

When a resin plate in the present invention is produced by a solvent adhesion method, the resin plate can be produced in a way such that a methyl methacrylate polymer is molded into a plate shape, separately a resin composition containing a methyl methacrylate resin and a vinylidene fluoride resin is molded into a film shape, and a solvent capable of dissolving either one or both of the plate and the film is applied onto the surface of the plate and/or the film so that the plate and the film are laminated. After being laminated, the solvent is volatilized, whereby the resin plate and the film are integrally laminated onto each other to obtain an intended resin plate.

When a resin plate in the present invention is produced by a polymerization adhesion method, the resin plate can be produced in a way such that a methyl methacrylate polymer is molded into a plate shape, separately a resin composition containing a methyl methacrylate resin and a vinylidene fluoride resin is molded into a film shape, and a polymerizable adhesive is applied onto the surface of the plate or the film so that the plate and the film are laminated. After being laminated, the polymerizable adhesive is polymerized, whereby the plate and the film are integrally laminated onto each other to obtain an intended resin plate. Examples of the polymerizable adhesive include a polymerizable adhesive obtainable by adding a polymerization initiator to the same monomer as is described above as a monomer composing a methyl methacrylate-styrene copolymer, a methyl methacrylate resin or a vinylidene fluoride resin. The polymerization initiator may be a thermal polymerization initiator for initiating the polymerization of a monomer by heating or may be a photo polymerization initiator for initiating the polymerization of a monomer by irradiating with light. For polymerizing such a polymerization initiator, the initiator is heated or irradiated with light depending on the utilized polymerization initiator.

When a resin plate in the present invention is produced by a cast polymerization method, the resin plate can be produced in a way such that a resin composition containing a methyl methacrylate resin and a vinylidene fluoride resin is molded into a film shape to dispose the resulting film in a polymerizing cell, into which then a monomer for obtaining a methyl methacrylate polymer or a partial polymer thereof is injected so as to be polymerized. A polymerization initiator may be added to the monomer or the partial polymer, whereby being polymerized after being injected into the polymerizing cell.

Thus obtained resin plate (resin laminate) in the present invention can be used for various kinds of uses indoors and outdoor such as an illuminated sign board, an illumination cover a light diffusing plate used for the front side or the back side of a display device.

When a base layer (A) composing a resin plate (C) contains a light diffusing agent, the resin plate can be used as a light-diffusing and light-guide plate (sheet). The light-diffusing and light-guide plate (sheet) guides a light from a light source such as a cold cathode fluorescent lamp and an LED (light-emitting diode) while diffusing the light, and can be used for a light source device utilized as a backlight of a liquid crystal display and the like. When a resin plate in the present invention is used as a light-diffusing and light-guide plate (sheet), the resin plate maybe used as a light diffusing plate composing a directly-beneath-light type backlight for illuminating from the back face of a display, or may be used as a light diffusing plate composing an edge-light type backlight for illuminating from the lateral face thereof.

A light-diffusing and light-guide plate (sheet) is commonly utilized for a light source device tends to easily absorb moisture in the air depending on a temperature change accompanying the switch-on and switch-off of a light source, whereas a resin plate (C) in the present invention has little deformation due to the absorption of moisture, and therefore, can inhibit odd noise accompanying the deformation. Also, when a resin plate in the present invention is used as a light guide plate disposed on the back side of a liquid crystal cell, there is less malfunction of the liquid crystal cell due to a deformation of the light guide plate because of little deformation due to little absorption of moisture.

When a resin plate in the present invention containing a light diffusing agent is used as a lighting cover, it is preferred to provide fine irregularities on at least one surface of the plate, in which the surface is utilized as a so-called matting surface reflecting incident light while scattering the light. Such irregularities preferably have a ten-point average roughness (Rz) of about 1 μm to about 5 μm and an average peak distance (Sm) of about 10 μm to about 300 μm. When the resin plate has a ten-point average roughness (Rz) of less than about 5 μm and/or an average peak distance (Sm) of more than about 300 μm on the at least one surface, it tends to be difficult that the surface works as a dull surface because of directly reflecting incident light. When the resin plate has a ten-point average roughness of more than about 50 μm and/or an average peak distance (Sm) of less than about 10 μm on the at least one surface, the plate tends to be weaken against impact (shock).

When the irregularities are produced, for example, by a coextrusion method, it is preferred that insoluble particles are contained in at least one of a methyl methacrylate polymer for base layer (A) or a resin composition containing a methyl methacrylate resin and a vinylidene fluoride resin for surface layer (B) so as to be then coextruded. The insoluble particles to be used may have a weight-average particle diameter of about 1 μm to about 50 μm. Preferably, the insoluble particles are contained in a resin composition for surface layer (B) containing a methyl methacrylate resin, a vinylidene fluoride resin and an ultraviolet absorbing agent, in the amounts of about one (1) part by weight to about 30 parts by weight with respect to 100 parts by weight of the total amount of the methyl methacrylate resin and the vinylidene fluoride resin.

Alternatively, the irregularities may be formed, for example, by roll transfer or by a cast polymerization method in which the irregularities are provided in a polymerizing cell and are transferred to the resin placed into the cell.

A resin plate in the present invention has a superior transparency, little deformation due to moisture absorption and a superior light resistance.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2003-087639 filed on Mar. 27, 2003, indicating specification, claims, drawings and summary, are incorporated herein by reference in their entirety.

### EXAMPLE

The present invention is described in more detail by reference to the following Examples, which should not be construed as a limitation upon the scope of the present invention.

A resin plate obtained in each of Examples and Comparative Examples was evaluated in the following manners.

(1) Total Light Transmittance (Tₜ)

Total light transmittance (Tₜ) was measured by using a haze transmittance meter [‘HR-100’ manufactured by MURAKAMI COLOR RESEARCH LABORATORY] in accordance with JIS K 7361.

(2) Hiding Property (I₅/I₀)

Hiding property (I₅/I₀) was measured by using a automatic goniophotometer [‘GP-1R’ manufactured by MURAKAMI COLOR RESEARCH LABORATORY] under the conditions that the intensity of the transmitted light at a transmission angle of 0° by vertical incident light was to be as I₀, and the intensity of the transmitted light at a transmission angle of 5° by vertical incident light was to be as I₅.

(3) Light Diffusibility (I₇₀/I₀)

Light diffusibility (I₇₀/I₀) was measured by using a automatic goniophotometer [‘GP-1R’ manufactured by MURAKAMI COLOR RESEARCH LABORATORY] under the conditions that the intensity of the transmitted light at a transmission angle of 0° by vertical incident light was to be as I₀, and the intensity of the transmitted light at a transmission angle of 70° by vertical incident light was to be as I₇₀.

(4) Evaluation of Warpage due to Water Absorption

A resin plate to be evaluated was cut out so as to obtain a test piece thereof, which was interposed between two sheets of steel flat plates and was held in the air at a temperature of 90° C. for 5 hours while being maintained in a plane shape, and thereafter was stood to be cooled to be dried for 24 hours. Next, this test piece was held at a room temperature (of about 25° C.) while only one surface thereof was being immersed in pure water. After 24 hours, each of the quantity (mm) of warping up in four corners of the test piece was respectively measured, and the average value thereof was used as a degree of warpage of the resin plate due to water absorption.

(5) Light Resistance

A resin plate to be evaluated was cut out so as to obtain a test piece thereof having a size of 6 cm×7 cm, and then L*, a* and b* of the light transmitted through this test piece were measured by a spectral color difference meter [‘SZ-Σ80’ manufactured by NIPPON DENSHOKU INDUSTRIES CO., LTD.] in accordance with JIS K 7103. This test piece was then continuously irradiated with ultraviolet rays at a temperature of 60° C. for 500 hours by using an ultraviolet irradiating device [‘ATLAS-UVCON’ manufactured by TOYO SEIKI CO., LTD.] to thereafter measure L*, a* and b* of the transmitted light in the same manner as described above. Using the results of the measurements, ΔE of the resin plate before and after irradiating ultraviolet rays was calculated.

(6) Surface Roughness

Ten-point average roughness (Rz) and average peak distance (Sm) were measured by using a surface roughness measuring machine [‘SURFCOM550A’ manufactured by Tokyo Seimitsu CO., LTD.] in accordance with JIS B 0601.

Resins used in Examples and Comparative Examples are as follows.

MS resin is a copolymer of 60 parts by weight of methyl methacrylate and 40 parts by weight of styrene, and has a refractive index of 1.53.

MA resin is a copolymer of 96 parts by weight of methyl methacrylate and 4 parts by weight of methyl acrylate, and has a refractive index of 1.49.

FV resin is a polyvinylidene fluoride homopolymer having a refractive index of 1.42.

Light diffusing agents used in Examples and Comparative Examples are as follows.

Light diffusing agent (1) is made of copolymer particles of 95 parts by weight of styrene and 5 parts by weight of divinylbenzene, and has a refractive index of 1.59 and a weight-average particle diameter of 6 μm.

Light diffusing agent (2) is made of copolymer particles of 50 parts by weight of styrene and 50 parts by weight of methyl methacrylate, and has a refractive index of 1.54 and a weight-average particle diameter of 11 μm.

Light diffusing agent (3) is made of crosslinked siloxane-based polymer particles [‘TOSPAR120’ manufactured by GE TOSHIBA SILICONES CO., LTD.], and has a refractive index of 1.43 and a weight-average particle diameter of 2 μm]

Light diffusing agent (4) is made of crosslinked siloxane-based polymer particles [‘TORAYFIL DY33-719’ manufactured by DOW CORNING TORAY SILICONE CO., LTD.], and has a refractive index of 1.42 and a weight-average particle diameter of 2 μm.

Light diffusing agent (5) is made of calcium carbonate particles [‘CUBE30AS’ manufactured by MARUO CALCIUM CO., LTD.], and has a refractive index of 1.61 and a weight-average particle diameter of 4 μm.

Insoluble particles used in Examples and Comparative Examples are as follows.

Insoluble particles (1) are crosslinked methyl methacrylate-based polymer particles [‘TECHPOLYMER MBX5’ manufactured by SEKISUI PLASTICS CO., LTD.], and have a refractive index of 1.49 and a weight-average particle diameter of 5 μm].

Insoluble particles (2) are talc particles [manufactured by NIPPON TALC CO., LTD.], and have a refractive index of 1.56 and a long-side particle diameter of 21 μm.

Ultraviolet absorbing agent (UVA) used in Examples and Comparative Examples are as follows.

UVA (1) is a 2-(paramethoxybenzylidene)dimethyl malonate [‘Sanduvor PR-25’ manufactured by CLARIANT K. K.], which is a compound represented in the above-described formula (1) in which X¹ is a methoxy group and a substitution position thereof is a para-position, and R¹ and R² are methyl groups].

UVA (2) is a 2-(2-hydroxy-5-methylphenyl)-2H-benzotriazole [‘SUMISORB 200’ manufactured by SUMITOMO CHEMICAL CO., LTD.].

Hindered amines used in Examples and Comparative Examples are as follows.

HALS is a bis (2,2,6,6-tetramethyl-4-piperidyl) sebacate [‘ADEKA STAB LA-77’ manufactured by ASAHI DENKA CO., LTD.].

It is noted that the weight-average particle diameters of these light diffusing agents and insoluble particles are weight-average particle diameters measured by using a microtrac particle size analyzer (light diffraction scattering particle diameter measuring machine) [‘Model 9220 FRA’ manufactured by NIKKISO CO., LTD.], while a long side particle diameter of insoluble particles (2) [talc particles] was measured by observing with a microscope.

### Examples 1 and 2 and Comparative Example 1

UVA (1) (0.01 part by weight) and MA resin (100 parts by weight) were mixed with each other by a Henschel mixer and were melt-kneaded by a first extruder [a screw diameter of 40 mm, a single axial type, with avent, manufactured by TANABE PLASTICS CO., LTD.] while being heated, whereby obtaining a first melt-kneaded product.

Meanwhile, an ultraviolet absorbing agent, MA resin and FV resin in the amounts shown respectively in Table 1 were mixed by a Henschel mixer and were melt-kneaded by a second extruder [a screw diameter of 20 mm, a single axial type, with a vent, manufactured by TANABE PLASTICS CO., LTD.] while being heated, whereby obtaining a second melt-kneaded product respectively.

In such a manner that the first melt-kneaded product obtained above is made into a base layer and the second melt-kneaded product obtained above is made into surface layers, the first melt-kneaded product and the second melt-kneaded product were supplied from the first extruder and the second extruder to a two-kind three-layer distribution type feed block die [manufactured by TANABE PLASTICS CO., LTD.] respectively so as to be coextrusion-molded at an extrusion resin temperature of 250° C., whereby obtaining a resin plate having a width of 23 cm, a length of 80 cm and a thickness of 2 mm. This resin plate had a three-layer constitution such that the surface layers were laminated on both surfaces of the base layer, each of the surface layers having a thickness of 0.1 mm and the base layer having a thickness of 1.8 mm. The results of evaluating the resin plate are shown in Table 1. A test piece used for measuring a degree of warpage had a size of 5 cm×5 cm.

TABLE 1

| | MA Resin | FV Resin | UVA (1) | Degree | |
|---|---|---|---|---|---|
| | (parts by | (parts by | (parts by | of Warpage | Tt |
| | weight) | weight) | weight) | (mm) | (%) |
| Example 1 | 75 | 25 | 0.015 | 0.47 | 92 |
| Example 2 | 50 | 50 | 0.015 | 0.24 | 93 |
| Comparative | 100 | 0 | 0.015 | 0.72 | 93 |
| Example 1 | | | | | |

### Examples 3 to 6

UVA (2) (0.01 part by weight) and MA resin (100 parts by weight) were mixed with each other by a Henschel mixer and were melt-kneaded by the same first extruder as was used in Example 1 while being heated, whereby obtaining a first melt-kneaded product.

Meanwhile, 0.015 part by weight of UVA (1) and MA resin and FV resin in the amounts shown respectively in Table 2 were mixed by a Henschel mixer and were melt-kneaded by the same second extruder as was used in Example 1 while being heated, whereby obtaining a second melt-kneaded product.

In such a manner that the first melt-kneaded product obtained above is made into a base layer and the second melt-kneaded product obtained above is made into surface layers, the first melt-kneaded product and the second melt-kneaded product were supplied from the first extruder and the second extruder to a two-kind two-layer distribution type multi-manifold die [manufactured by TANABE PLASTICS CO., LTD.] respectively so as to be coextrusion-molded at an extrusion resin temperature of 260° C., whereby obtaining a resin plate having a width of 22 cm, a length of 80 cm and a thickness of 2 mm. This resin plate had a two-layer constitution such that the surface layer was laminated on one surface of the base layer, the surface layer having a thickness of 0.1 mm and the subatrate layer having a thickness of 1.9 mm. The results of evaluating the resin plate are shown in Table 2. A test piece used for measuring a degree of warpage had a size of 20 cm×20 cm.

TABLE 2

| | MA Resin | FV Resin | UVA (1) | Degree | |
|---|---|---|---|---|---|
| | (parts by | (parts by | (parts by | of Warpage | Tt |
| | weight) | weight) | weight) | (mm) | (%) |
| Example 3 | 90 | 10 | 0.015 | 2.60 | 93 |
| Example 4 | 80 | 20 | 0.015 | 2.44 | 93 |
| Example 5 | 70 | 30 | 0.015 | 2.25 | 93 |
| Example 6 | 60 | 40 | 0.015 | 1.45 | 93 |

### Example 7

A resin plate was obtained by the same process as is Example 6 except for increasing the amount of the second melted resin supplied to the multi-manifold die. This resin plate had a two-layer constitution such that the surface layer was laminated on one surface of the base layer, the surface layer having a thickness of 0.2 mm and the base layer having a thickness of 1.8 mm. The results of evaluating the resin plate are shown in Table 3. A test piece used for measuring a degree of warpage had a size of 20 cm×20 cm.

TABLE 3

| | MA Resin | FV Resin | UVA (1) | Degree | |
|---|---|---|---|---|---|
| | (parts by | (parts by | (parts by | of Warpage | Tt |
| | weight) | weight) | weight) | (mm) | (%) |
| Example 7 | 60 | 40 | 0.015 | 0.21 | 93 |

### Examples 8 to 11 and Comparative Example 2

UVA (1) (0.01 part by weight), a light diffusing agent (1) (0.8 part by weight), a light diffusing agent (2) (0.8 part by weight) and 100 parts by weight of MA resin were mixed by a Henschel mixer and were melt-kneaded by the same first extruder as was used in Example 1 while being heated, whereby obtaining a first melt-kneaded product.

Meanwhile, UVA (1) in the amount shown in Table 4 and 8 parts by weight of insoluble particles were added to MA resin and FV resin in the amounts shown in Table 4 and were mixed by a Henschel mixer. The resulting mixture was melt-kneaded by the same second extruder as was used in Example 1 while being heated, whereby obtaining a second melt-kneaded product.

TABLE 4

| | | | | Insoluble |
|---|---|---|---|---|
| | MA Resin | FV Resin | UVA (1) | Particles (1) |
| | (parts by | (parts by | (parts by | (parts by |
| | weight) | weight) | weight) | weight) |
| Example 8 | 80 | 20 | 0.5 | 8 |
| Comparative | 100 | 0 | 0.5 | 8 |
| Example 2 | | | | |
| Example 9 | 70 | 30 | 0.05 | 8 |
| Example 10 | 70 | 30 | 0.5 | 8 |
| Example 11 | 70 | 30 | 1.0 | 8 |

In such a manner that the first melt-kneaded product obtained above is made into a base layer and the second melt-kneaded product obtained above is made into a surface layer, the first melt-kneaded product and the second melt-kneaded product were supplied from the first extruder and the second extruder to the same two-kind two-layer distribution type multi-manifold die as was used in Example 3 respectively so as to be coextrusion-molded at an extrusion resin temperature of 245° C., whereby obtaining a resin plate having a width of 22 cm, a length of 80 cm and a thickness of 2 mm. This resin plate had a two-layer constitution such that the surface layer was laminated on one surface of the base layer, the surface layer having a thickness of 0.05 mm and the base layer having a thickness of 1.95 mm. The results of evaluating the resin plate are shown in Table 5. A test piece used for measuring a degree of warpage had a size of 18 cm×18 cm.

TABLE 5

| | | Degree | | | | | |
|---|---|---|---|---|---|---|---|
| | Tt | of Warpage | I₅/I₀ | I₇₀/I₀ | | Rz | Sm |
| | (%) | (mm) | (%) | (%) | ΔE | (μm) | (μm) |
| Example 8 | 63 | 1.74 | 99 | 20 | 3.3 | 3.3 | 33 |
| Example 9 | 64 | 1.90 | 99 | 19 | 3.9 | 3.0 | 30 |
| Comparative | 63 | 3.35 | 99 | 20 | 0.7 | 3.1 | 36 |
| Example 2 | | | | | | | |
| Example 10 | 63 | 1.69 | 99 | 20 | 8.7 | 3.2 | 30 |
| Example 11 | 63 | 1.76 | 99 | 20 | 1.0 | 3.3 | 33 |

### Examples 12 to 15 and Comparative Example 3

UVA (1) (0.02 part by weight), HALS (0.01 part by weight), a light diffusing agent (1) (0.65 part by weight) and a light diffusing agent (4) (0.65 part by weight) were added to 100 parts by weight of MS resin and were mixed by a Henschel mixer. The resulting mixture was melt-kneaded by the same first extruder as was used in Example 1 while being heated, whereby obtaining a first melt-kneaded product.

Meanwhile, an ultraviolet absorbing agent and an insoluble particle in the amounts shown in Table 2 were added to MA resin and FV resin in the amounts shown in Table 6, into which 0.5 part by weight of a mixture (a surfactant) of sodium cetyl sulfate and sodium stearyl sulfate was further added. The resulting mixture was mixed by a Henschel mixer and was melt-kneaded by a second extruder [a screw diameter of 20 mm, a single axial type, with a vent, manufactured by TANABE PLASTICS CO., LTD.] while being heated, whereby obtaining a second melt-kneaded product.

TABLE 6

| | | | | Insoluble |
|---|---|---|---|---|
| | MA Resin | FV Resin | UVA (1) | Particles (1) |
| | (parts by | (parts by | (parts by | (parts by |
| | weight) | weight) | weight) | weight) |
| Example 12 | 70 | 30 | 0.5 | 8 |
| Example 13 | 80 | 20 | 0.5 | 8 |
| Comparative | 100 | 0 | 0.5 | 8 |
| Example 3 | | | | |
| Example 14 | 70 | 30 | 0.05 | 8 |
| Example 15 | 70 | 30 | 1.0 | 8 |

In such a manner that the first melt-kneaded product obtained above is made into a base layer and the second melt-kneaded product obtained above is made into a surface layer, the first melt-kneaded product and the second melt-kneaded product were supplied from the first extruder and the second extruder to the same two-kind two-layer distribution type multi-manifold die as was used in Example 3 respectively so as to be coextrusion-molded at an extrusion resin temperature of 245° C., whereby obtaining a resin plate having a width of 22 cm, a length of 80 cm and a thickness of 2 mm. This resin plate had a two-layer constitution such that the surface layer was laminated on one surface of the base layer, the surface layer having a thickness of 0.05 mm and the base layer having a thickness of 1.95 mm. The results of evaluating the resin plate are shown in Table 7.

TABLE 7

| | | Degree | | | | | |
|---|---|---|---|---|---|---|---|
| | Tt | of Warpage | I₅/I₀ | I₇₀/I₀ | | Rz | Sm |
| | (%) | (mm) | (%) | (%) | ΔE | (μm) | (μm) |
| Example 12 | 61 | 1.07 | 99 | 22 | 7.8 | 3.1 | 29 |
| Example 13 | 61 | 1.23 | 99 | 22 | 8.2 | 2.9 | 30 |
| Comparative | 61 | 2.07 | 99 | 22 | 3.9 | 3.2 | 33 |
| Example 3 | | | | | | | |
| Example 14 | 61 | 1.05 | 99 | 21 | 12.6 | 2.9 | 30 |
| Example 15 | 61 | 1.09 | 99 | 22 | 3.9 | 3.2 | 33 |

### Example 16

A resin plate having a width of 22 cm, a length of 80 cm and a thickness of 2 mm was obtained by the same process as in Example 13 except for replacing the multi-manifold die with the same two-kind three-layer distribution type feed block die as was used in Example 1. The obtained resin plate had a three-layer constitution such that the surface layers were laminated on both surfaces of the base layer, each of the surface layers having a thickness of 0.03 mm and the base layer having a thickness of 1.94 mm. The results of evaluating the resin plate are shown in Table 8.

TABLE 8

| | | Degree | | | | | |
|---|---|---|---|---|---|---|---|
| | Tt | of Warpage | I₅/I₀ | I₇₀/I₀ | | Rz | Sm |
| | (%) | (mm) | (%) | (%) | ΔE | (μm) | (μm) |
| Example 16 | 63 | 0.96 | 98 | 18 | 8.8 | 3.2 | 33 |

### Example 17 and Comparative Example 4

UVA (3) (0.01 part by weight), a light diffusing agent (2) (3 parts by weight) and a light diffusing agent (3) (2 parts by weight) were added to 100 parts by mass of MA resin and were mixed by a Henschel mixer. The resulting mixture was melt-kneaded by the same first extruder as was used in Example 1 while being heated, whereby obtaining a first melt-kneaded product.

Meanwhile, UVA (3) and insoluble particles (2) in the amount shown in Table 9 were added to MA resin and FV resin in the amounts shown in Table 9, into which 0.5 part by weight of a mixture (a surfactant) of sodium cetyl sulfate and sodium stearyl sulfate was further added. The resulting mixture was mixed by a Henschel mixer and was melt-kneaded by the same second extruder as was used in Example 1 while being heated, whereby obtaining a second melt-kneaded product.

TABLE 9

| | | | | Insoluble |
|---|---|---|---|---|
| | MA Resin | FV Resin | UVA (3) | Particles (2) |
| | (parts by | (parts by | (parts by | (parts by |
| | weight) | weight) | weight) | weight) |
| Example 17 | 80 | 20 | 0.1 | 15 |
| Comparative | 100 | 0 | 0.1 | 15 |
| Example 4 | | | | |

In such a manner that the first melt-kneaded product obtained above is made into a base layer and the second melt-kneaded product obtained above is made into surface layers, each of the first melt-kneaded product and the second melt-kneaded product was supplied to the same two-kind three-layer distribution type feed block die as was used in Example 1 so as to be coextrusion-molded at an extrusion resin temperature of 245° C., whereby obtaining a resin plate having a width of 22 cm, a length of 80 cm and a thickness of 2 mm. This resin plate had a three-layer constitution such that the surface layers were laminated on both surface of the base layer, each of the surface layers having a thickness of 0.03 mm and the base layer having a thickness of 1.94 mm. The results of evaluating the resin plate are shown in Table 10.

TABLE 10

| | | Degree | | | | | |
|---|---|---|---|---|---|---|---|
| | Tt | of Warpage | I₅/I₀ | I₇₀/I₀ | | Rz | Sm |
| | (%) | (mm) | (%) | (%) | ΔE | (μm) | (μm) |
| Example 17 | 60 | 2.03 | 99 | 22 | 10.8 | 2.3 | 70 |
| Comparative | 60 | 3.10 | 99 | 22 | 9.9 | 2.8 | 75 |
| Example 4 | | | | | | | |

What is claimed is:

1. A resin plate comprising a base layer and a surface layer placed on at least one side of the base layer, wherein the base layer is made from a methyl methacrylate polymer having about 30% by weight or more of a methyl methacrylate unit as a monomer unit, and the surface layer has a thickness of about 5 μm to about 500 μm and is made from a resin composition containing about 40 parts by weight to about 95 parts by weight of a methyl methacrylate resin and about 5 parts by weight to about 60 parts by weight of a vinylidene fluoride resin with respect to 100 parts by weight in total of the methyl methacrylate resin and the vinylidene fluoride resin.

2. A resin plate according to claim 1, wherein the base layer has a thickness of about 0.8 mm to about 5 mm.
